(19) United States
(12) Patent Application Publication
(10) Pub. No.: US 2026/0111563 A1
(43) Pub. Date: Apr. 23, 2026

(54) AUTONOMOUS ADAPTIVE CODE EVOLUTION FOR ENHANCED CYBERSECURITY

(71) Applicant: SAP SE, Walldorf (DE)

(72) Inventor: Ankur Gandotra, Gurugram (IN)

(73) Assignee: SAP SE, Walldorf (DE)

(21) Appl. No.: 18/923,288

(22) Filed: Oct. 22, 2024

(51) Int. Cl. G06F 21/57; G06F 21/53

(52) U.S. Cl. CPC G06F 21/577; G06F 21/53; G06F 2221/033

(57) ABSTRACT

Techniques and solutions are provided for enhancing software security through autonomous adaptive code evolution. Code variants are generated and analyzed using various methods, such as static code analysis or execution in controlled environments, against known and predictive future threats or vulnerabilities to determine whether they exhibit improved security. Variants can be generated using techniques such as genetic programming, instruction substitution, control flow alteration, or dead code insertion. Types of code modifications that result in improved security are prioritized when generating variants. In one example, reinforcement learning is used to identify code adaptations that enhance security, including those which do so without overly compromising functionality or performance. Continuous performance monitoring can be used to help ensure that security adaptations do not degrade software functionality, and an intelligent rollback mechanism can be used to revert to a previous state if negative impacts are detected.

### FIELD

The present disclosure generally relates to security-related software analysis and development.

### BACKGROUND

Security issues in software code are typically addressed through a combination of manual code reviews, automated vulnerability scanning tools, and reactive patches following the discovery of security vulnerabilities. Code reviews, often conducted by developers or security professionals, are intended to identify potential vulnerabilities in the codebase before deployment. However, the effectiveness of manual reviews can be limited by human error, time constraints, and the increasing complexity of modern software systems. While automated tools have been developed to aid in the detection of known security vulnerabilities, these tools often focus on specific patterns or previously identified weaknesses, leaving potential novel vulnerabilities undetected. Further, manual effort is typically required to modify code to ameliorate even detected vulnerabilities.

A common practice in the industry is to address security vulnerabilities reactively, particularly in response to known threats or breaches. This reactive approach can involve emergency patches or hotfixes when an exploit has already been discovered and is actively being leveraged by malicious actors. These fixes, while needed to address a vulnerability, often come at the expense of thorough testing and code optimization, leading to potential performance degradation or unintended consequences elsewhere in the software. Moreover, the time-sensitive nature of these reactive changes can introduce further risks if patches are applied hastily, without adequate validation.

Another significant issue arises from the fact that security patches are often applied in isolation, addressing a specific vulnerability without considering the broader security context of the entire codebase. This piecemeal approach can lead to a situation where one vulnerability is fixed, but the code remains vulnerable in other, less obvious ways. Furthermore, the reliance on human intervention for implementing code changes increases the risk of inconsistencies, particularly when security patches are implemented across large, distributed teams.

Despite advancements in security best practices, many organizations continue to struggle with maintaining a proactive security posture. Regular security audits and vulnerability scans, while helpful, are not always sufficient to anticipate future security threats or detect sophisticated attacks. As the pace of software development continues to accelerate, driven by methodologies such as continuous integration and continuous deployment (CI/CD), the challenge of proactively addressing security issues becomes even more pronounced. The growing use of open-source libraries and third-party components can worsen the problem, as vulnerabilities in these external dependencies may not be identified or addressed in a timely manner.

Accordingly, room for improvement exists in determining code vulnerabilities and generating updated code that is secure in the face of these vulnerabilities.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and solutions are provided for enhancing software security through autonomous adaptive code evolution. Code variants are generated and analyzed using various methods, such as static code analysis or execution in controlled environments, against known and predictive future threats or vulnerabilities to determine whether they exhibit improved security. Variants can be generated using techniques such as genetic programming, instruction substitution, control flow alteration, or dead code insertion. Types of code modifications that result in improved security are prioritized when generating variants. In one example, reinforcement learning is used to identify code adaptations that enhance security, including those which do so without overly compromising functionality or performance. Continuous performance monitoring can be used to help ensure that security adaptations do not degrade software functionality, and an intelligent rollback mechanism can be used to revert to a previous state if negative impacts are detected.

In one aspect, the present disclosure provides a process of modifying code to improve security. An orchestrator computing process causes a first variant of first software code to be generated by modifying at least a portion of the first software code using at least a first modification computing routine in a collection of a plurality of modification computing routines available to the orchestrator computing process. The orchestrator computing process causes code of the first variant to be analyzed against code vulnerability definitions in a vulnerability repository to provide evaluation results, or subjects the first variant to a security threat selected from a plurality of security threats in a threat library to provide execution results.

The priority of the at least first modification computing routine is increased based on determining that evaluation results or the execution results improve security of the first software code. The priority is stored in metadata, configuration data, operational data, or any other data structure or data type accessible to the orchestrator computing process.

The orchestrator computing process causes a second variant of second software code to be generated by modifying at least a portion of the second software code using the at least first modification computing routine. The at least first modification computing routine is selected using the priority of the at least first modification computing routine, thus improving a probability of obtaining a more secure code variant. The second software code is the first software code, the first variant of the first software code, or another variant of the first software code.

The present disclosure also includes computing systems and tangible, non-transitory computer-readable storage media configured to carry out, or includes instructions for carrying out an above-described method. As described herein, a variety of other features and advantages can be incorporated into the technologies as desired.

### BRIEF DESCRIPTION OF THE DRAWINGS

FIG. 1 is a diagram of a computing environment in which disclosed techniques can be implemented.

FIGS. 2A and 2B provide example code for implementing a vulnerability repository.

FIGS. 3A and 3B provide example code for implementing a threat library.

FIGS. 4A-4J provide example code for generating and testing code variants.

FIG. 5 a flowchart of a process of modifying code to improve security.

FIG. 6 is a diagram of an example computing system in which some described embodiments can be implemented.

FIG. 7 is an example cloud computing environment that can be used in conjunction with the technologies described herein.

### DETAILED DESCRIPTION

### Example 1—Overview

Security issues in software code are typically addressed through a combination of manual code reviews, automated vulnerability scanning tools, and reactive patches following the discovery of security vulnerabilities. Code reviews, often conducted by developers or security professionals, are intended to identify potential vulnerabilities in the codebase before deployment. However, the effectiveness of manual reviews can be limited by human error, time constraints, and the increasing complexity of modern software systems. While automated tools have been developed to aid in the detection of known security vulnerabilities, these tools often focus on specific patterns or previously identified weaknesses, leaving potential novel vulnerabilities undetected. Further, manual effort is typically required to modify code to ameliorate even detected vulnerabilities.

A common practice in the industry is to address security vulnerabilities reactively, particularly in response to known threats or breaches. This reactive approach can involve emergency patches or hotfixes when an exploit has already been discovered and is actively being leveraged by malicious actors. These fixes, while needed to address a vulnerability, often come at the expense of thorough testing and code optimization, leading to potential performance degradation or unintended consequences elsewhere in the software. Moreover, the time-sensitive nature of these reactive changes can introduce further risks if patches are applied hastily, without adequate validation.

Another significant issue arises when security patches are often applied in isolation, addressing a specific vulnerability without considering the broader security context of the entire codebase. This piecemeal approach can lead to a situation where one vulnerability is fixed, but the code remains vulnerable in other, less obvious ways. Furthermore, the reliance on human intervention for implementing code changes increases the risk of inconsistencies, particularly when security patches are implemented across large, distributed teams.

Despite advancements in security best practices, many organizations continue to struggle with maintaining a proactive security posture. Regular security audits and vulnerability scans, while helpful, are not always sufficient to anticipate future security threats or detect sophisticated attacks. As the pace of software development continues to accelerate, driven by methodologies such as continuous integration and continuous deployment (CI/CD), the challenge of proactively addressing security issues becomes even more pronounced. The growing use of open-source libraries and third-party components can worsen the problem, as vulnerabilities in these external dependencies may not be identified or addressed in a timely manner.

Accordingly, room for improvement exists in determining code vulnerabilities and generating updated code that is secure in the face of these vulnerabilities.

The present disclosure provides techniques that can be used to automatically generate variants of software code. For example, techniques such as semantic-preserving code transformations can replace code with functionally equivalent code, such as by substituting instructions, altering the control flow (order of operations) of the code, or inserting “dead code” that does not affect the code's functionality but changes its structure. Random mutations can also be used, as can automated refactoring techniques, such as breaking complex functions into smaller functions, removing inline method calls, or renaming variables.

Code mutations refer to alterations or modifications in computing code, typically source code, that are introduced to achieve specific objectives, such as enhancing code security. These mutations may be generated randomly or based on predetermined patterns. Random mutations involve making arbitrary changes, such as altering variable names, modifying control flow structures, or adjusting conditional logic. Pattern-based mutations, by contrast, are guided by a database of known vulnerabilities or established best practices in coding.

Some operations in generating code variants can be similar to actions performed by a software compiler. However, code transformation techniques may have a larger set of changes that can be made, and can make changes that might make the code less performant or otherwise less compliant with “best” coding practices. This is consistent with the goal of a compiler to produce efficient code, compared with the goal of a code transformer to create secure code, even if there is a performance cost to the increased security.

These mutations may occur at predefined intervals or in response to specific triggers, such as newly discovered vulnerabilities, system errors, or security breaches. The frequency of mutation can depend on the criticality of the system and the sensitivity of the data being protected. In high-risk environments, the system may continuously monitor for vulnerabilities and initiate the mutation process upon detecting any threats. In lower-risk systems, mutations may be scheduled at regular intervals (e.g., weekly or monthly) to balance security needs with system stability.

Code variants can be evaluated both for security and functionality. For example, a code analysis can be performed on code variants to determine whether the code has potential vulnerabilities. Code variants can also be subjected to simulated security threats, such as attack vectors for known threats or attack vectors that exploit potential vulnerabilities, even if an active threat has not yet occurred.

Functionality testing can determine whether a code variant produces identical outcomes to the original code, which can take advantage of tests, such as unit tests, written for the original code. The performance of the code variant, such as response times, memory use, or processor use, can also be compared with metrics of the original code.

Further variants can be produced using genetic programming. That is, two or more code variants can be combined, such as combining a portion of one variant with a portion of another variant. The resulting code variant can be subjected to security and functionality testing, as described above. Results of security and functionality testing can be used to select variants for use in genetic programming. That is, rather than using all variants in genetic programming, only highest performing variants are selected. The genetic programming approach can be carried out for multiple generations, starting with an original set of code variants.

Information regarding changes made to variants and variant performance can be used in reinforcement learning. For example, particular actions can be given a score in terms of how well a particular change improves security or functionality. That information can be used to develop strategies that can be applied to other code variants, including for a different software code base. For example, the reinforcement learning may determine from analyzing a set of variants that replacing dynamic SQL queries with parameterized SQL queries improves security. This knowledge can then be applied in generating new variants for other sections of code or selecting the most secure variants in different contexts.

If a code variant is deployed in place of a prior code version, performance of the code variant can be monitored. If the performance regresses beyond a threshold, remedial action can be taken, such as rolling back the deployment of the variant in favor of the prior version. In other cases, the remedial action can include replacing the code variant with a different code variant.

### Example 2—Example Variant Generation and Testing Computing Environment

FIG. 100 illustrates an example computing environment 100 in which disclosed techniques can be implemented. The computing environment 100 includes a code repository 108. The code repository 108 stores code that is to be analyzed for vulnerabilities and for which code variants will be generated. The code repository 108 can also store the variants, and information, such as in code metadata, which can be used to relate code variants to other code variants or to “original” code from which the variant was generated, such as using version information or by having a code variant reference at least its immediate “parent” code version or versions.

The computing environment 100 can also include a threat library 112 that stores a collection of predefined threat vectors 114. The threat library 112 can include a set of known vulnerabilities, such as specific virus signatures, malware behaviors, or vulnerabilities in software libraries and components. These entries can include actual viruses, malware, and other forms of malicious software, in addition to more abstract threat patterns and simulated attack scenarios. The malware may include known viruses, worms, trojans, ransomware, or other malicious software that is currently used in real-world attacks. Each entry in the threat library can represent a particular type of exploit or malicious activity designed to exploit weaknesses in software. These entries may consist of executable code, scripts, or patterns of code that can be applied to test the resilience of a code variant.

The threat vectors 114 stored in the threat library 112 can target specific code weaknesses. These weaknesses can include common security vulnerabilities such as buffer overflow attacks, SQL injection, cross-site scripting, or other known security issues. Some threat vectors may represent theoretical or abstract vulnerabilities that have not yet been exploited in the wild, while others will consist of actual viruses and malware that perform harmful actions, such as encrypting data, stealing sensitive information, or granting remote access to unauthorized users.

Each threat vector 114 can be associated with metadata that identifies the nature of the threat, the type of vulnerability it targets, and the conditions under which it might be effective. For instance, a threat vector 114 targeting SQL injection may be applicable only to applications with database interactions, while a buffer overflow threat vector might be relevant for code that handles low-level memory operations. Malware threat vectors can include details such as the platform they target, their mode of attack (e.g., network propagation or file encryption), and the potential damage they cause.

Execution of the threat vectors 114 against particular code can include running the code in a controlled (“sandboxed”) execution environment 116 where the threat vector is introduced. The threat vector 114 attempts to exploit a known weakness in the code, and the execution environment monitors how the code variant responds. If the code is successfully exploited, the environment flags the code as vulnerable to that particular threat. For example, if the code allows a buffer overflow to occur, this can be detected by monitoring tools that capture abnormal memory usage or other anomalous behavior indicative of an exploit. Similarly, if a virus or malware manages to infiltrate the code and execute malicious payloads, this would also be flagged as a successful compromise.

The computing environment 100 can also include a vulnerability repository 118, which stores information about known or theoretical code vulnerabilities. The vulnerability repository 118 can include entries related to specific coding practices, design patterns, or code structures that are susceptible to exploitation. Vulnerabilities in the vulnerability repository 118 can include issues such as unvalidated input, improper memory management, insecure authentication protocols, or failure to sanitize data. Entries can include detailed descriptions of the specific conditions under which the vulnerability occurs, example code snippets, and relevant programming languages or platforms. For example, an entry can describe how failing to validate user input can lead to SQL injection attacks in web applications, or how the improper use of dynamic memory allocation in C can lead to buffer overflow vulnerabilities.

Vulnerabilities in the vulnerability repository 118 can be tied to particular security threats in the threat library 112, but the repository is not limited to vulnerabilities that are actively exploited. Instead, it provides a comprehensive index of potentially unsafe practices, deprecated techniques, and architectural flaws that could expose code to security threats, including future security threats.

The vulnerability repository 118 can classify vulnerabilities by severity, likelihood of exploitation, and potential impact on system security. These classifications can also be applied to threats in the threat library 112. In addition to these classification metrics, each entry can include remediation steps, coding best practices, or pointers to secure alternatives. The vulnerability repository 118 can be used as a reference for identifying vulnerabilities, but also serves as a tool that can be used to mitigate or avoid vulnerabilities.

The computing environment 100 includes a code analyzer 124. The code analyzer 124 can interact with the vulnerability repository 118 to conduct static code analysis. Instead of executing threats, the code analyzer 124 scans the code to identify whether it contains any patterns, structures, or coding practices that match entries in the vulnerability repository 118. The code analyzer 124 can apply rule-based or machine learning-based techniques to recognize insecure code fragments. In a specific example, the code analyzer 124 can be, can access the functionality of, or be a modified version of SAP CVA (Code Vulnerability Analyzer), of SAP SE, of Walldorf, Germany.

The code analyzer 124 can operate by parsing the code and comparing it against the signatures or descriptions in the repository. For example, the code analyzer 124 can detect the presence of hardcoded credentials, weak cryptographic algorithms, or inefficient resource management. Upon finding a match, the code analyzer 124 can provide results indicating the vulnerable portion of the code, its associated risk, and possible remediation strategies, such as code changes that have been successful in mitigating a vulnerability when made to other code. Remediation strategies can be correlated with functionality to generate code variants that are modified according to a particular remediation strategy.

In addition to performing static analysis through tools such as SAP CVA, the code analyzer 124 can also access the functionality of SonarQube, an open-source platform for continuous inspection of code quality and security. SonarQube allows for early detection of vulnerabilities, code smells, and maintainability issues across a variety of programming languages. By integrating SonarQube, or similar functionality, the code analyzer 124 can help ensure compliance with security standards, such as OWASP Top 10 and SANS Top 25, and provide continuous feedback as part of a CI/CD pipeline.

Use of the threat library 112 or the vulnerability repository 118 allows vulnerabilities to be flagged, even if they have not yet been exploited, providing a proactive defense mechanism. If vulnerabilities are identified, additional variants can be generated and tested, until a variant is identified that is secure and has acceptable performance characteristics.

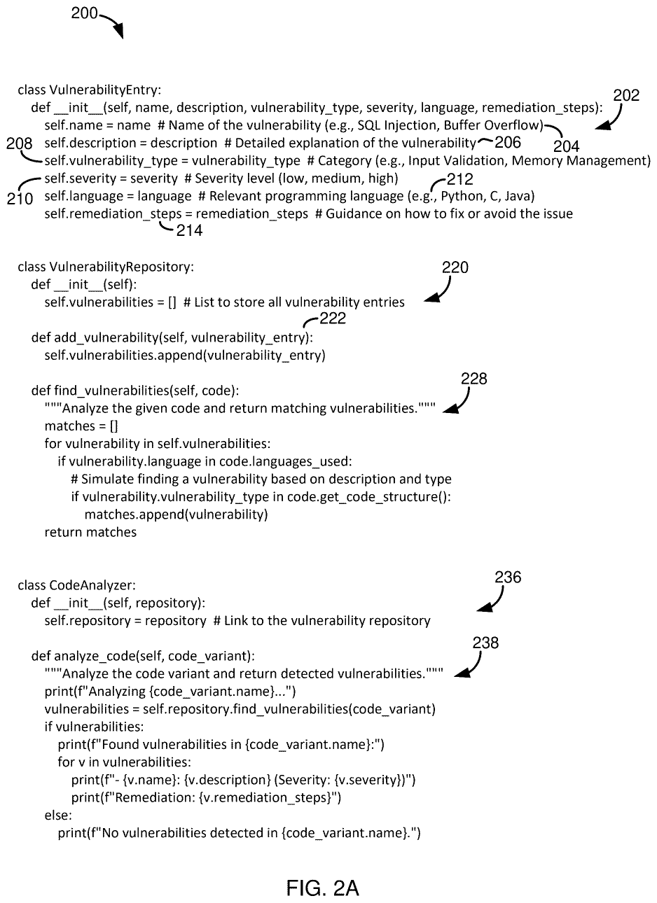

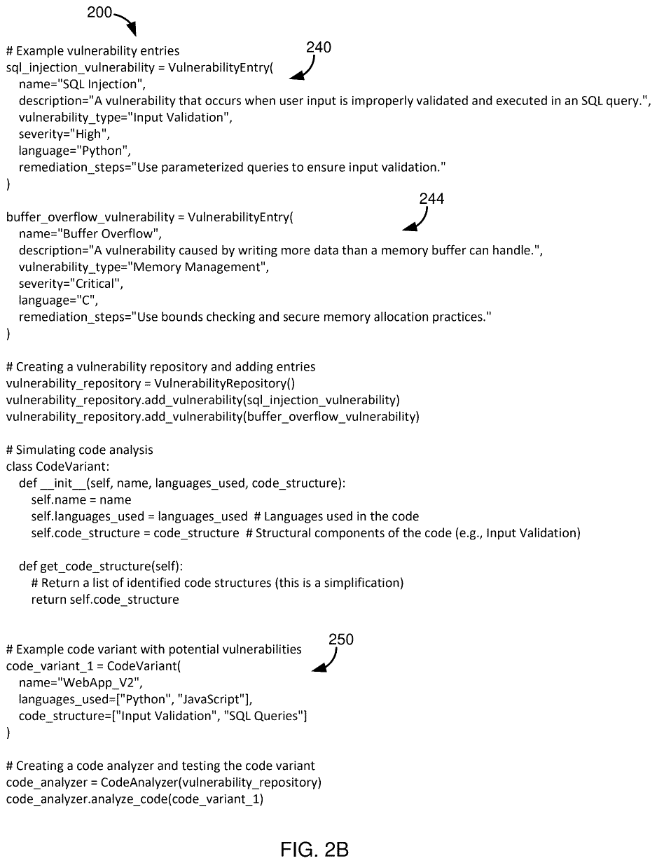

FIGS. 2A-2B provide example code 200 for generating a vulnerability repository 118 and analyzing code using the code analyzer 124. In FIG. 2A, the VulnerabilityEntry class 202 provides the foundation for how individual vulnerabilities are represented within the system. Each instance of this class corresponds to a known vulnerability that may exist in software, including details used for both identifying and remediating the issue. The attributes of this class include the name 204 of the vulnerability, which typically refers to a known security issue, such as “SQL Injection” or “Buffer Overflow.” A description attribute 206 provides a more detailed explanation of how the vulnerability operates, typically specifying the conditions under which the vulnerability arises, its potential consequences, and any associated risks.

The vulnerability_type attribute 208 categorizes the vulnerability based on broader security categories, such as “Input Validation” for issues where user input is not properly sanitized or “Memory Management” for flaws related to improper handling of memory resources, such as in languages like C. This classification allows for more organized storage and retrieval of vulnerabilities in the repository. The severity attribute 210 indicates the relative impact of the vulnerability, with typical values such as “low,” “medium,” “high,” or “critical,” enabling the system to prioritize vulnerabilities that pose the greatest risk.

The language attribute 212 specifies the programming languages in which the vulnerability is relevant. For example, a vulnerability related to memory management may be pertinent to C or C++, but not to Python, while SQL injection vulnerabilities may be common in web application languages like Python, PHP, or JavaScript. The remediation_steps attribute 214 provides guidance for addressing the vulnerability, such as identifying code variant techniques that can be applied to modify the code to avoid or fix the issue. For example, for SQL injection, the remediation can be linked to a variant generation technique that rewrites code to use parameterized queries, while for buffer overflows, the vulnerability can be associated with a variant generation technique to include proper bounds checking or the use of safer memory allocation practices.

The VulnerabilityRepository class 220 acts as a container for storing and organizing multiple instances of VulnerabilityEntry. It includes an internal list, vulnerabilities, where all known vulnerabilities are stored. The repository allows new vulnerabilities to be added through the add_vulnerability method 222, which appends the vulnerability entry to the list. This enables the repository to expand dynamically as new vulnerabilities are discovered.

The main function of the repository is to provide the find_vulnerabilities method 228, which is responsible for scanning a given codebase (in the form of a Code Variant) and identifying any matching vulnerabilities. The method 228 compares the code variant's attributes, specifically its programming languages and code structure, with the entries in the repository. If the code uses a language relevant to a particular vulnerability and contains a code structure that matches the vulnerability type, the method identifies the vulnerability as a match and returns it for further analysis.

For instance, if the code variant is written in Python and contains SQL queries, and the repository contains an entry for SQL injection vulnerabilities specific to Python, the repository will flag this vulnerability and return it as a potential issue in the code. This allows the system to perform static code analysis without needing to execute the code. The code analyzer 124 can recognize vulnerabilities purely based on the structure and logic of the code itself.

The CodeAnalyzer class 236 integrates with the VulnerabilityRepository 220 to perform the actual analysis of a code variant. The analyze_code method 238 initiates the process by accepting a Code Variant object, which represents the code under analysis. The analyzer calls the find_vulnerabilities method 228 from the repository to retrieve any vulnerabilities that match the code variant's structure and programming languages.

If vulnerabilities are detected, the code analyzer 124 can output a detailed report for each one, or provide this information to a variant generator for use in generating new code variants. This report can include the name and description of the vulnerability, along with the severity level, which a variant generator can use to prioritize code changes to address higher priority vulnerabilities.

The example code 200 provided includes several specific vulnerabilities, illustrated in FIG. 2B. For instance, the SQL injection vulnerability 240 is stored in the repository with a description explaining how improper user input validation in SQL queries can allow an attacker to manipulate database operations. The remediation step suggests using parameterized queries as a defense mechanism. Similarly, a buffer overflow vulnerability 244 is stored in the repository, indicating how writing data beyond the bounds of a memory buffer can lead to serious security issues, with the recommended fix being the use of bounds checking and secure memory allocation. Again, rather than, or in addition to, having a textual description of a remediation strategy, a vulnerability can be identified using a code that can be used to call a variant generator computing routine that suitable modified the code, or to otherwise operationally link the vulnerability so such as routine.

The code variant WebApp_V2 250 represents a web application that is written in Python and JavaScript and includes structures related to input validation and SQL queries. When the code analyzer 124 examines this code variant, it matches the SQL injection vulnerability in the repository due to the presence of SQL queries in the code and the fact that Python is one of the languages used. The code analyzer 124 then generates a report detailing the vulnerability and how to address it.

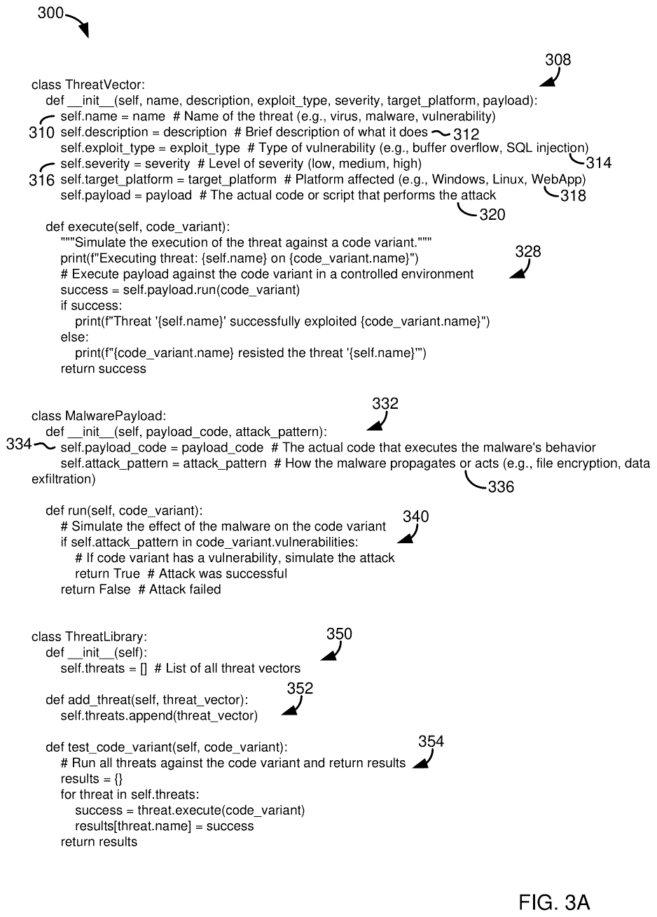

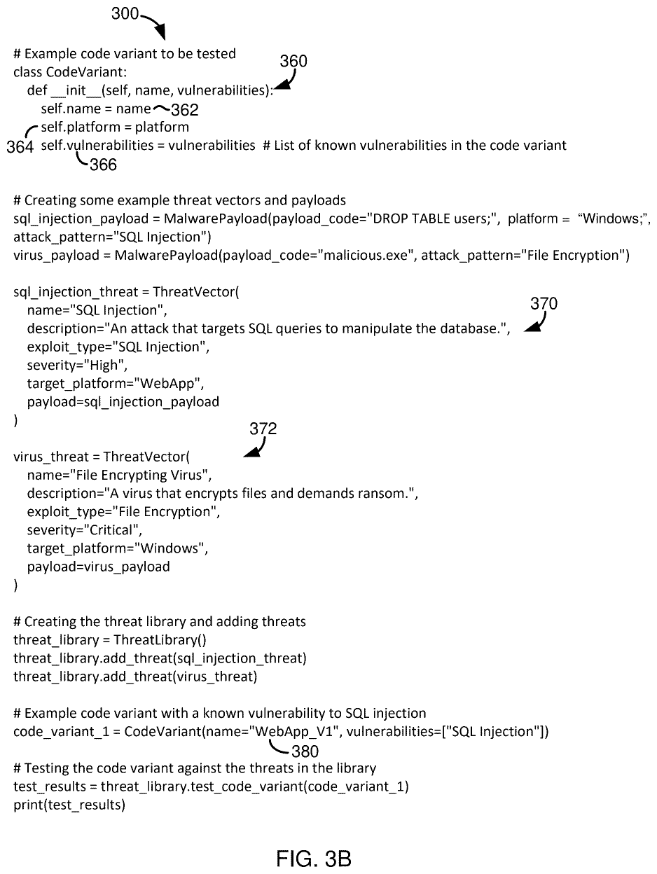

FIGS. 3A and 3B illustrate example code 300 for the threat library 112 and the threat vectors 114. The Threat Vector class 308 represents a specific type of threat, such as a virus or an SQL injection attack, designed to exploit vulnerabilities in a software system. Each instance of this class includes attributes that define the threat. The name attribute 310 identifies the threat, often corresponding to a well-known security exploit, while the description 312 provides additional detail about the threat's behavior and the context in which it can be effective. The exploit_type attribute 314 categorizes the nature of the exploit, such as SQL injection or file encryption, and the severity attribute 316 indicates the potential damage the threat could cause, typically ranging from low to critical. The target_platform attribute 318 specifies the platform the threat is intended to target, such as Windows, Linux, or a web application, and the payload attribute 320 contains the actual code or script that carries out the malicious behavior.

The execute method 328 simulates the execution of the threat against a Code Variant, running the payload and determining whether it successfully exploits the code variant's vulnerabilities. This dynamic testing can be performed in a controlled environment and allows the system to assess the resiliency of the code under real-world attack scenarios.

The Payload class 332 encapsulates the malicious behavior of the threat. It includes the payload_code 334, which represents the specific code or logic used to perform the exploit, such as a SQL injection statement or ransomware encryption logic. The attack_pattern 336 defines how the attack is carried out, such as through SQL queries or file encryption.

The run method 340 simulates the effect of the attack on a target code variant. It checks whether the attack pattern matches any vulnerabilities present in the code. If the vulnerability exists, the attack is considered successful, and the method returns a positive result indicating that the code variant was compromised. Otherwise, the attack fails, and the code variant is considered resistant to that particular threat.

The ThreatLibrary class 350 serves as a repository for storing multiple instances of the Threat Vector class 308. The threats are stored in an internal list and can be added dynamically using the add_threat method 352, which allows the library to expand as new threats are defined. The test_code_variant method 354 runs all stored threats against a given Code Variant. For each threat, the method 354 calls the execute function, simulating the behavior of the threat in a sandboxed environment. The method 354 records the outcome of each test, determining whether the code variant was successfully exploited by any of the threats in the library.

Turning to FIG. 3B, the Code Variant class 360 represents the software being tested for vulnerabilities. It includes attributes such as the name 362 of the code variant, the platform 364 for which the code is written, and a list 366 of known vulnerabilities that are present in the code. These vulnerabilities represent weaknesses that could potentially be exploited by threats. During the testing process, the vulnerabilities are compared against the threat vectors in the ThreatLibrary, determining whether the code is susceptible to attack. The Code Variant class 360 allows the system to simulate the behavior of real-world applications under attack, providing insight into the effectiveness of security measures and the need for further remediation, such as the generation and testing of additional code variants.

The code 300 defines two threat vectors: an SQL injection attack 370 and a ransomware virus 372. The SQL injection attack 370 exploits improperly validated SQL queries, allowing an attacker to manipulate the database, while the ransomware virus 372 encrypts files on the target platform and demands payment to restore access. Both threats are stored in the ThreatLibrary 350, where they are prepared to be executed against any code variant.

The code variant WebApp_V2 380 represents a web application written in Python and JavaScript, with known vulnerabilities related to SQL injection. When the test_code_variant method 354 is called, the system runs both the SQL injection and ransomware threats against the code variant. The SQL injection threat successfully exploits the code, demonstrating a security flaw, while the ransomware virus fails to execute, as the web application is not vulnerable to file encryption attacks.

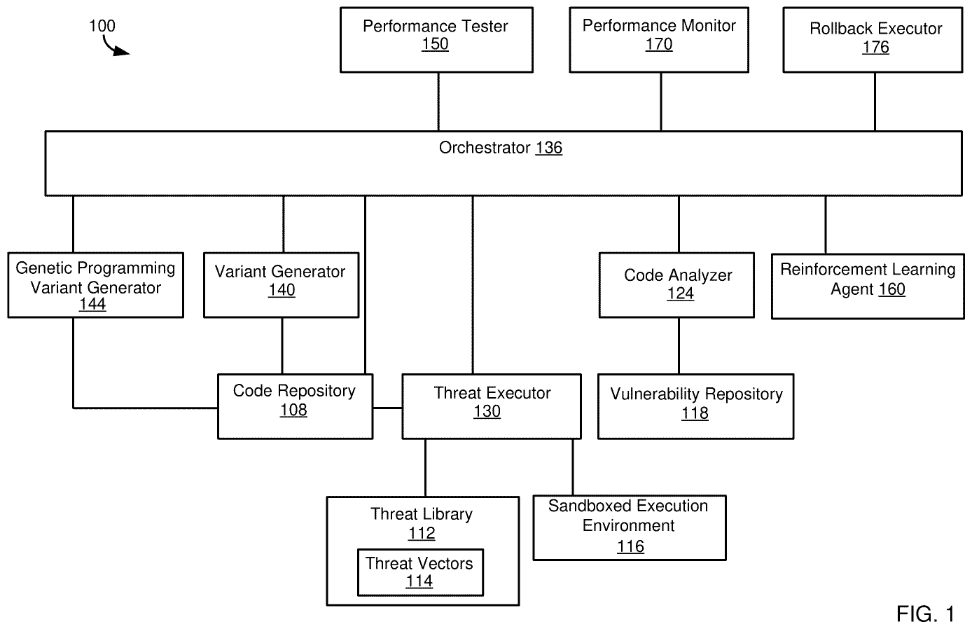

Returning to FIG. 1, threats from the threat library 112 can be executed on the code using a threat executor 130, where the threat executor 130 can call execute methods of the vectors 114, as in the code 300. In addition to applying known threat vectors, the threat executor 130 can also perform dynamic application security testing (DAST), interacting with the running application to simulate real-world usage scenarios and identify vulnerabilities that only manifest during runtime.

The threat executor 130 can perform this dynamic analysis by sending crafted requests, interacting with forms, and simulating various user behaviors, assessing how the application responds to inputs. By analyzing the application during execution, the threat executor 130 can detect vulnerabilities such as SQL injection, cross-site scripting (XSS), and insecure session management. Furthermore, the threat executor 130 can identify configuration issues like missing security headers or weak authentication mechanisms. Through this dynamic analysis, the threat executor 130 helps ensure that both known and hidden vulnerabilities in the application are addressed. In one implementation, the threat executor 130 can leverage tools with functionality similar to OWASP ZAP (Zed Attack Proxy) to assist in this real-time analysis.

An orchestrator 136 can communicate with the code repository 108, the threat library 112, the vulnerability repository 118, the code analyzer 124, and the threat executor 130, along with other components of the computing environment 110. The orchestrator 136 is responsible for generating code variants, causing the code variants to be analyzed using the code analyzer 122 and tested using the threat executor 130.

The orchestrator 136 can call, or include, the functionality of a variant generator 140. The variant generator 140 generates variants of code in the code repository, and can use one or more of a variety of techniques. For example, the variant generator 140 can use semantic-preserving transformations to ensure that the modified code behaves identically to the original code, despite structural changes. These transformations are useful when the goal is to create variations that are harder to reverse-engineer or detect, without compromising the correctness of the code.

One such transformation may include instruction substitution, where a specific operation is replaced with another operation that produces the same outcome. For example, the expression “x=a+b” could be replaced with “x=b+a” or using a bitwise shift to replace multiplication by powers of two, such as replacing “x*2” with “x<<1.”

Another technique is control flow alteration, which changes the sequence of code execution without altering the result. For example, as shown below, a “for” loop can be rewritten as a “while” loop or as a recursive function. This transformation allows for code variants where the same result is achieved via different control flow structures.

```
Original:
for (int i = 0; i < n; i++) {
  sum += arr[i];
}
Variant:
int i = 0;
while (i < n) {
  sum += arr[i];
  i++;
}
```

Dead code insertion is another form of transformation that introduces additional code that does not impact the program's behavior but alters its structure, as shown below. This technique can increase the complexity of the code, making it more difficult to analyze without changing its functionality.

Original:
sum = a + b;
Variant:
sum = a + b;
int dead_var = 0; // Dead code insertion with no operational effect

A metamorphic approach generates code variants by altering not just the code structure but its appearance. One such method involves modifying the control flow graph (CFG) of the program by reorganizing execution paths, creating functionally equivalent variants. This reorganization can include breaking down blocks of code into smaller segments and reordering them as long as the data dependencies are maintained, such as shown in the example below.

```
Original:
if (x > 0) {
  foo( );
} else {
  bar( );
}
Variant:
x <= 0 ? bar( ) : foo( ); // Using a ternary operator
```

Automated refactoring can produce variants by restructuring code in a manner that maintains its original functionality. For instance, a refactoring technique can extract methods from a larger function to break down complex operations into smaller, more manageable ones, as shown below. This transformation yields modular code variants while preserving functionality.

```
Original:
void process( ) {
  int result = calculateSomething( );
  log(result);
}
Variant:
void process( ) {
  int result = calculateSomething( );
  logResult(result);
}
void logResult(int result) {
  log(result); // Extracted method
}
```

Similarly, refactoring can involve renaming variables or methods, as shown below. Although this transformation is superficial, it changes the appearance of the code, creating a variant that behaves identically to the original version.

Original:
int a = getValue( );
int b = calculate(a);
Variant:
int alpha = getValue( );
int beta = calculate(alpha); // Renamed variables

In some cases, random mutations can be applied to code, where small changes such as altering constants or adjusting operators can be introduced, as in the example code below. These mutations maintain functionality but introduce minor variations that can diversify the codebase, which can increase security.

Original:
int threshold = 100;
Variant:
int threshold = 101; // Small mutation

Mutation of constants or operators may involve altering conditional expressions, thereby introducing slight but non-functional differences in the code. For example, adjusting the threshold in a conditional statement, as shown below, can create a variant with a different logical structure but the same outcome.

```
Original:
if (a > 10) {
  doSomething( );
}
Variant:
if (a >= 11) { // Altering operator and constant
  doSomething( );
}
```

Code generation techniques can mimic certain behaviors of compilers. For example, instruction expansion, as illustrated below, can be used to transform concise operations into more verbose forms. While a compiler might inline code for performance, a variant generator may expand instructions to increase complexity.

Original:
x += y;
Variant:
x = x + y; // Less concise form of the same operation

Similarly, loop transformations can be applied to change the structure of the code without affecting its functionality. For example, loops that have been unrolled for clarity or performance can be rolled back into a compact loop structure. This transformation increases the abstraction of the code, making it more difficult to interpret while maintaining the same behavior, as in the example below.

Original:
int sum = 0;
sum += arr[0];
sum += arr[1];
sum += arr[2];
sum += arr[3];
Variant:
int sum = 0;
for (int i = 0; i < 4; i++) {
sum += arr[i];
}

In addition to the inlining and loop conversion techniques already discussed, the variant generator 140 can use a variety of other compiler-like transformations to generate functionally equivalent variants of code. For instance, expression expansion and simplification techniques can be used to alter the structure of an expression without changing its outcome. In expression expansion, a single concise expression is transformed into multiple steps, introducing complexity into the code while maintaining the same behavior, as illustrated below:

Original:
x = (a + b) * c;
Variant:
int temp = a + b;
x = temp * c; // Expanded the expression

Similarly, the variant generator 140 can perform constant unfolding, where expressions involving constants that would typically be simplified at compile time are instead expanded into their component operations, as in the code below. This process delays evaluation to runtime, adding complexity to the code, which may be more secure.

Original:
int result = 5 * 10;
Variant:
int a = 5;
int b = 10;
int result = a * b; // Unfolded the constants into variables

Another technique involves strength reduction reversal, which alters the complexity of operations. While compilers often optimize code by replacing expensive operations with more efficient ones, such as replacing multiplication by a power of two with a bit shift, the variant generator may reverse such optimizations to increase complexity, as illustrated below.

Original (optimized):
x = x << 1; // Bitwise shift
Variant:
x = x * 2; // Replaced with multiplication

The variant generator 140 may also reorder independent instructions within a block of code, a transformation that mirrors how compilers optimize instruction execution for performance, as illustrated in the code below. By changing the order of instructions that do not rely on each other's results, the structure of the code can be altered without affecting its functionality.

```
Original:
  a = getA( );
  b = getB( );
  Variant:
  b = getB( );
  a = getA( ); // Reordered the independent instructions
```

In addition, the variant generator 140 can employ tail call optimization (TCO) reversal. Compilers often optimize recursive functions by applying tail call optimization, reducing the overhead of recursive calls. The variant generator can reverse this process, as illustrated below, converting an optimized tail-recursive call into a full recursive call, increasing the structural complexity of the code, creating a variant that may be more secure than the original code.

```
Original (TCO-optimized):
int factorial(int n, int acc) {
  if (n == 1) return acc;
  return factorial(n − 1, n * acc); // Tail-recursive call
}
Variant (reversed optimization):
int factorial(int n) {
  if (n == 1) return 1;
  return n * factorial(n − 1); // Standard recursive call
}
```

Further, the variant generator 140 can manipulate function call substitution, where one function call is replaced with another function that provides the same output, as illustrated below. This can involve using different overloaded functions or replacing a library function with an equivalent custom implementation.

Original:
int result = Math.pow(a, 2);
Variant:
int result = a * a; // Replaced library call with direct multiplication

In certain cases, switch statement rearrangement may be performed. The variant generator 140 can alter the structure of decision-making code by rearranging switch case statements or converting them into equivalent if-else statements, as illustrated below, changing the appearance of the control flow without affecting behavior.

```
Original (switch statement):
switch (x) {
  case 1: foo( ); break;
  case 2: bar( ); break;
}
Variant (if-else):
if (x == 1) {
  foo( );
} else if (x == 2) {
  bar( );
}
```

In addition to the transformations described earlier, the variant generator 140 can also replace a function call with the function's body, a transformation commonly referred to as inlining, and illustrated below. Inlining removes the overhead associated with a function call by directly embedding the function's logic into the calling code, creating a variant where the function's operations are expanded within the original code.

Original (with function call and separate function):
int calculate(int a, int b) {
return a + b;
}
sum += calculate(a, b);
Variant (inlined function):
sum += (a + b); // Inlined the function body

In this example, the original code calls the function calculate to perform the addition, while the variant directly inlines the logic of the calculate function into the code, removing the function call and embedding the function's body within the calling code. This transformation removes the need for the function call overhead while maintaining the functionality of the original code.

The actions described above, particularly those described as compiler-like, can be carried out in either “direction.” That is, for example, the variant generator 140 may perform either constant folding or constant unfolding. A main goal of forming variants is to produce code that is less vulnerable to threats, without necessarily considering whether the code might be more or less efficient.

The transformations described above, particularly those that introduce randomness or untargeted changes, help reduce the vulnerability of code to security threats, including viruses and malware. Many forms of malware rely on recognizing specific patterns or sequences of instructions to exploit vulnerabilities. By altering these patterns through techniques such as constant unfolding, control flow reordering, inserting dead code, inlining function bodies, or reversing optimizations, the variant generator 140 disrupts the malware's ability to identify exploitable targets. These transformations also complicate static analysis tools and thwart signature-based detection systems, making the code more difficult to recognize, analyze, and exploit. The overall effect of introducing structural diversity across code variants increases the code's resilience against attacks.

Variants can also be generated using a genetic programming variant generator 144. In some implementations, functionality of the genetic programming variant generator 144 is included in the variant generator 140. As opposed to making changes to a single code instance, the genetic programming variant generator 144 produces variants by combining two or more versions of code, which can be “original” code and one or more variants, or combinations of only variants of the original code, where the variants can be produced using the techniques of the variant generator 140, or prior results of using the genetic programming variant generator 144.

Genetic programming operates by simulating biological evolution in the context of code, where different versions or “variants” of the code are treated as individuals in a population. The genetic programming variant generator 144 applies evolutionary techniques, such as crossover (recombination) and mutation, to generate new code variants. In crossover, two or more code variants are selected, and sections of their code are exchanged at specific “crossover points.” These newly combined variants inherit characteristics from both “parent” versions, producing code with novel combinations of features, including combining features of both parents that can increase code security.

Crossover points are typically selected such that the resulting hybrid code is syntactically correct and semantically meaningful. The choice of crossover points can take a variety of factors into account. Structural alignment between the different code versions is typically analyzed to ensure that the parts being swapped are compatible. For example, crossover points might be chosen at function boundaries, loops, or blocks of code that perform similar tasks, such as mathematical operations or data processing. This helps ensure that the resulting code does not introduce syntax errors or break the logical flow of execution. For instance, if two functions perform iterative tasks using loops, the system could choose the loops themselves as crossover points. The basic control flow structures and variable usage can be matched up, facilitating recombination.

Another factor is the identification of modular or interchangeable regions within the code. Code modules that encapsulate specific functionalities, such as helper functions or isolated operations, can often be swapped or recombined without affecting the larger program structure. For example, if both code variants contain a segment that handles data input and output, these segments may be considered modular and therefore suitable for crossover. This allows for the generation of new code variants that retain the functional independence of the modules while introducing variability in their internal implementations.

The history of mutation effects (effects of a particular variant generating computing routine) on specific regions of the code can inform crossover point selection. If previous mutations to certain areas of the code have consistently led to improvements, such as increased security robustness or computational efficiency, the genetic programming variant generator can prioritize those regions for future crossover events. For instance, if a loop optimization in one variant led to a significant improvement in performance, the system might favor recombining that loop with another variant's corresponding loop to explore further optimizations. Similar considerations can be used by the variant generator 140 in determining what variant generating computing routines to apply to code to generate a new variant.

Crossover points can also be selected based on semantic similarity between code regions. In more advanced implementations, the system can analyze the behavior of different code sections, rather than merely their structure, to identify regions that perform related functions. For example, two code variants can both implement search algorithms but use different techniques (e.g., linear search versus binary search). While the specific implementations differ, the underlying function of searching through data is shared, making these sections candidates for crossover.

A fitness function can be used to evaluate the effectiveness of newly generated variants, but does not typically determine the initial crossover points directly. After crossover has been applied, the fitness function evaluates the resulting code based on predefined criteria, such as correctness, performance, security robustness, or memory usage. For example, the fitness function can test the execution time of a code variant, its ability to handle large inputs without crashing, or its resistance to certain security vulnerabilities. Feedback from the fitness function can then influence future crossover decisions (and, more generally, the application of variant generating computing routines) by highlighting which sections of the code produced desirable results. Over time, this feedback can guide the system to prioritize or avoid certain regions during crossover.

To illustrate, consider two code snippets written in Python, where the crossover mechanism would combine parts of these code versions:

```
# Version 1: Basic factorial function
def factorial(n):
  result = 1
  for i in range(1, n + 1):
    result *= i
  return result
# Version 2: Basic power function
def power(x, y):
  result = 1
  for i in range(y):
    result *= x
  return result
```

In this case, crossover points are selected based on structural alignment. Both functions use a for loop, making the loops suitable for recombination. The genetic programming variant generator selects the loop structures as crossover points, swapping them to create a new variant:

```
# Crossover Result
def factorial_power(n, y):
  result = 1
  for i in range(1, n + 1): # From factorial
    result *= i
  for j in range(y): # From power
    result *= n
  return result
```

Here, the crossover operator has combined the loop from the factorial function and inserted another loop from the power function. This variant combines logic from both parents, potentially producing novel behavior, or making the code more robust to security threats. The fitness function would then evaluate this new variant, testing factors like its execution efficiency or how well it handles edge cases, as well as looking at the variant for code vulnerabilities or susceptibility to threat vectors.

In some cases, crossover points can be dynamically adjusted based on fitness evaluations from previous generations. For example, if the fitness function consistently finds that optimizing certain segments of code-such as loops or conditionals-leads to better results, the system may increase the likelihood of selecting those regions for future crossover events. This iterative process allows the genetic programming variant generator 144 to evolve increasingly robust and optimized code variants.

After a variant is generated, by one or more of the variant generator 140 or the genetic programming variant generator 144, it can be analyzed by the orchestrator 136, such as by analyzing code for the variant using the vulnerabilities repository 118 or using the threat library 112, including evaluating a fitness function as described above. As described, variants can be tested to determine whether they maintain the desired functionality while performing within acceptable parameters. This can involve evaluating functional accuracy and performance efficiency, along with additional assessments such as profiling, regression testing, and code coverage analysis. The analysis can be initiated by the orchestrator 136, which can call, or include the functionality of, a performance tester 150.

To verify that the code variants preserve the correct functionality, accuracy testing is conducted. This typically involves applying the same unit tests originally developed for the base code. These unit tests check the correctness of individual components by validating inputs, ensuring that expected outputs are produced, and confirming that edge cases are handled properly. By running these tests on the variants, it is possible to confirm that the structural changes introduced do not alter the intended behavior. Any discrepancies between expected and actual outputs are flagged for further analysis. Test failures or performance anomalies can be mapped to the specific code sections where changes were made, making it possible to tie accuracy or performance issues to particular transformations in the code. This level of granularity allows for targeted refinement of the variants and helps identify whether certain changes lead to unintended consequences, which can be taken account when generating future code variants.

Performance testing evaluates the efficiency of the code variants in comparison to the original. Performance metrics such as response time, memory usage, and CPU utilization are measured. Response time testing assesses how quickly the variants complete specific tasks, which is typically important, as it directly affects a user's experience. Memory usage testing evaluates whether the variants consume excessive memory or introduce memory leaks, while CPU utilization testing helps identify any new bottlenecks or inefficiencies introduced by the code transformations. Profiling tools can be used to identify “hotspots” in the code, which are sections that consume disproportionate resources. By correlating these performance bottlenecks with the specific transformations applied to the code, further optimizations can be targeted to improve the overall efficiency of the variants.

Additional testing, such as stress and load testing, can be performed depending on the use case of the variant. Stress testing subjects the code variants to extreme conditions, such as high volumes of data or heavy concurrent usage, to evaluate their stability and robustness under pressure. Load testing, on the other hand, examines how the variants perform under typical usage scenarios to ensure they handle expected workloads without performance degradation. Both forms of testing help validate the reliability of the variants under various conditions and provide insights as to whether they are viable candidates for deployment.

Regression testing can be performed to help ensure that the integrity of the code is maintained in the variant, including its interactions with other code. This type of testing confirms that changes introduced by the code variants do not negatively affect other parts of a broader application or system.

In addition to testing accuracy and performance, code coverage analysis can be performed to verify that all execution paths in the code—including new or modified paths introduced by the variants—are exercised during testing. High coverage helps ensure that any potential issues arising from structural changes are identified early in the development cycle. By correlating code coverage metrics with the sections of code modified by the variant generator, disclosed techniques can help ensure that transformations are adequately tested and validated.

The results from these performance and accuracy tests can be compared against baseline metrics. Baselines can include the original code, as well as other known optimized or secure versions of the software, including previously generated and highly ranked or rated variants. Establishing multiple baselines allows for a deeper analysis of whether the variants provide improvements, degradations, or neutral changes in terms of performance and security.

Furthermore, in environments where energy efficiency is a concern, such as embedded or mobile systems, measuring the energy consumption of the code variants can be another important metric. By assessing power usage during the execution of variants, especially under high-load conditions, the orchestrator 136 can identify whether certain transformations inadvertently lead to increased energy consumption.

Information from security testing and performance testing can be used in a variety of ways. For example, the information can be used to guide operation of the variant generator 140, such as to adjust the priority of different variant generating techniques depending on how much they improved security or performance in prior variants. Similarly, the information can be used when determining crossover points by the genetic programming variant generator 144. Furthermore, the variants selected for combination by the genetic programming variant generator 144 can be those that exhibit a desired degree of security improvement and performance improvement, or at least those that have the lowest performance regression.

The generation of new variants can take advantage of reinforcement learning (RL), which is a type of machine learning where a software agent learns to make decisions by performing actions in an environment to maximize cumulative rewards. Unlike supervised learning, where the model is trained on a fixed dataset, reinforcement learning involves an agent that interacts with the environment, receives feedback in the form of rewards or penalties, and uses this feedback to improve its decision-making process over time.

In the context of generating and testing software variants, reinforcement learning can be applied to enhance the effectiveness of the variant generation process. A RL agent 160 operates within the computing environment 100, interacting with various components such as the code repository 108, threat library 112, vulnerability repository 118, and performance tester 150. The RL agent's goal is to generate code variants that improve security and performance metrics based on feedback from testing results.

In reinforcement learning, an agent learns to make decisions by interacting with its environment and receiving feedback in the form of rewards or penalties, which help guide future behavior. This process involves two key stages: exploration, where the agent tries different actions to gather more information about the environment, and exploitation, where the agent uses its current knowledge to choose the best action based on past experience.

The RL agent can be a Q-learning agent, which is a specific type of reinforcement learning (RL) agent that uses a technique called Q-learning to learn optimal actions in a given environment. Q-learning is a model-free RL algorithm that learns the value of taking a particular action in a particular state, which is known as the Q-value. The agent updates its Q-values based on the rewards it receives from the environment, allowing it to learn the best actions to take over time.

Q-learning works by initializing a Q-table, which is a matrix where each row represents a state and each column represents an action. Initially, all Q-values are set to zero or some arbitrary value. The agent selects an action based on the current state using an exploration-exploitation strategy, such as the epsilon-greedy method, where the agent sometimes chooses random actions (exploration) and sometimes chooses the action with the highest Q-value (exploitation). After taking the action, the agent receives a reward from the environment and transitions to a new state. The agent then updates the Q-value for the state-action pair using the Q-learning update rule:

$$Q ( s , a ) ← Q ( s , a ) + α [ r + γ {max}_{{a}^{′}} Q ( {s}^{′} , {a}^{′} ) - Q ( s , a ) ]$$

In this rule, Q(s, a) is the current Q-value for state (s) and action (a), α is the learning rate, r is the reward received after taking action (a) in state (s), γ is the discount factor, and

$${max}_{{a}^{′}} Q ( {s}^{′} , {a}^{′} )$$

is the maximum Q-value for the next state (s′) over all possible actions (a′).

In the context of generating and testing software variants, the Q-learning agent can be used to optimize the generation and selection of code variants. The agent generates an initial set of code variants using various techniques such as semantic-preserving transformations, random mutations, and automated refactoring. These variants are subjected to security and performance tests, and the results provide feedback in the form of rewards or penalties. The Q-learning agent uses this feedback to update its Q-values, prioritizing actions that have historically led to positive outcomes.

For example, if replacing dynamic SQL queries with parameterized SQL queries consistently improves security, the Q-learning agent will prioritize this action in future iterations. Similarly, the agent can determine optimal crossover points when combining code variants by analyzing the structure and behavior of the code. By considering factors such as structural alignment, modularity, and past mutation effects, the Q-learning agent dynamically adjusts crossover points to maximize the effectiveness of the resulting hybrid code.

Assume the agent generates a set of code variants and subjects them to security and performance tests. One variant demonstrates improved resistance to SQL injection attacks, resulting in a high reward. The agent updates the Q-value for the action of replacing dynamic SQL queries with parameterized queries. In future iterations, the agent is more likely to select this action, leading to the generation of more secure code variants. Conversely, if a variant introduces new vulnerabilities or degrades performance, the agent receives negative reinforcement. Over time, the agent refines its strategy based on continuous feedback, ensuring the generation of robust and efficient code variants.

Similar operations can be performed by RL agents that are not Q-learning agents. The main distinction of Q-learning is its use of a Q-table to represent the expected cumulative rewards for state-action pairs, whereas other RL algorithms may employ more complex representations, such as neural networks or policy functions, to achieve similar goals.

Once a code variant is deployed, its performance can be monitored by a performance monitor 170. The performance monitor 170 tracks various performance metrics of the deployed variant in real-time. These metrics can include response times, memory usage, processor utilization, and error rates. By collecting and analyzing this data, the performance monitor 170 can detect any deviations from expected behavior that may indicate performance degradation or the introduction of new errors.

Execution data is compared against predefined thresholds and baseline metrics established during the initial testing phase. If the performance monitor 170 detects that the variant's performance has regressed beyond acceptable limits, such as increased response times, excessive memory consumption, or a rise in error rates, it triggers an alert. This alert indicates that the deployed variant may be experiencing issues that could impact its overall functionality and user experience.

In addition to monitoring performance metrics, the performance monitor 170 can track the correctness of the code variant's output. By comparing the results produced by the variant against expected outcomes, the monitor can identify any discrepancies that may suggest the code is producing erroneous results.

When the performance monitor 170 identifies significant performance degradation or erroneous results, a rollback executor 176 can be activated. The rollback executor 176 is responsible for reverting the deployed variant to a previous, stable version of the code. The rollback executor 176 can retrieve the last known good version of the code from the code repository 108. This version is one that has been thoroughly tested and verified to meet all performance and security criteria. The rollback executor 176 then initiates the deployment of this stable version, replacing the problematic variant. During this process, the rollback executor 176 ensures that any necessary configurations and dependencies are correctly applied to the stable version to maintain consistency and functionality. Alternatively, such as if the prior code version had known security vulnerabilities, the rollback executor 176 can deploy a different variant, which as least during generation demonstrated acceptable security and performance.

Once the rollback is complete, the performance monitor 170 continues to track the performance of the newly deployed stable version. This ongoing monitoring helps verify that the rollback has successfully resolved the issues and that the software is operating within acceptable performance parameters. If further issues are detected, the rollback executor 176 can initiate additional rollbacks or other remedial actions as needed.

Generating code variants even in the absence of a specific vulnerability can be useful for maintaining robust software security and performance. This proactive approach offers several practical benefits, helping to ensure that the software remains resilient against potential threats.

One advantage of periodically generating and deploying code variants is that it increases the difficulty for malicious actors to develop effective threats. By continuously altering the code structure and behavior, the system introduces variability that complicates the efforts of attackers to identify and exploit vulnerabilities. This approach disrupts the typical attack vectors that rely on recognizing specific patterns or sequences of instructions within the code. As a result, the software becomes a moving target, making it more challenging for attackers to develop and deploy successful exploits.

Additionally, having a diverse set of code variants available can provide a rapid response mechanism in the event of a newly detected threat or vulnerability. When a new threat is identified, the system can quickly analyze the existing variants to determine which ones are most resilient against the specific attack vector. This allows for the immediate deployment of a secure variant, minimizing the window of exposure and reducing the risk of exploitation. By maintaining a pool of pre-tested variants, the system can respond swiftly to emerging threats, ensuring continuous protection.

Moreover, the periodic generation of code variants can serve as a form of continuous improvement for the software. Even in the absence of known vulnerabilities, this process allows for the exploration of new optimization techniques and security enhancements. By regularly testing and evaluating new variants, the system can identify incremental improvements that enhance overall performance and security.

### Example 3—Example Code Implementation

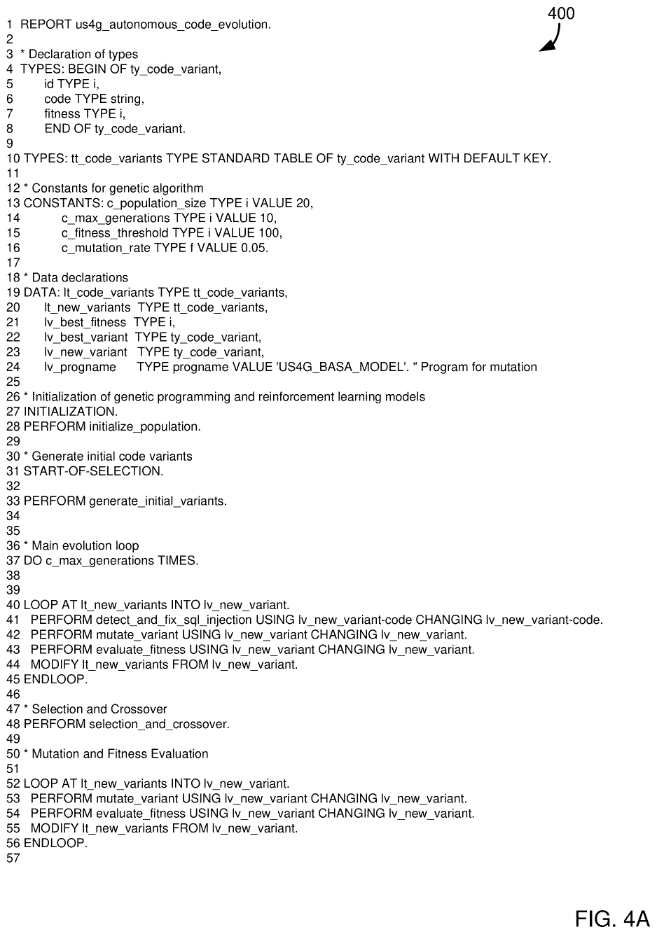

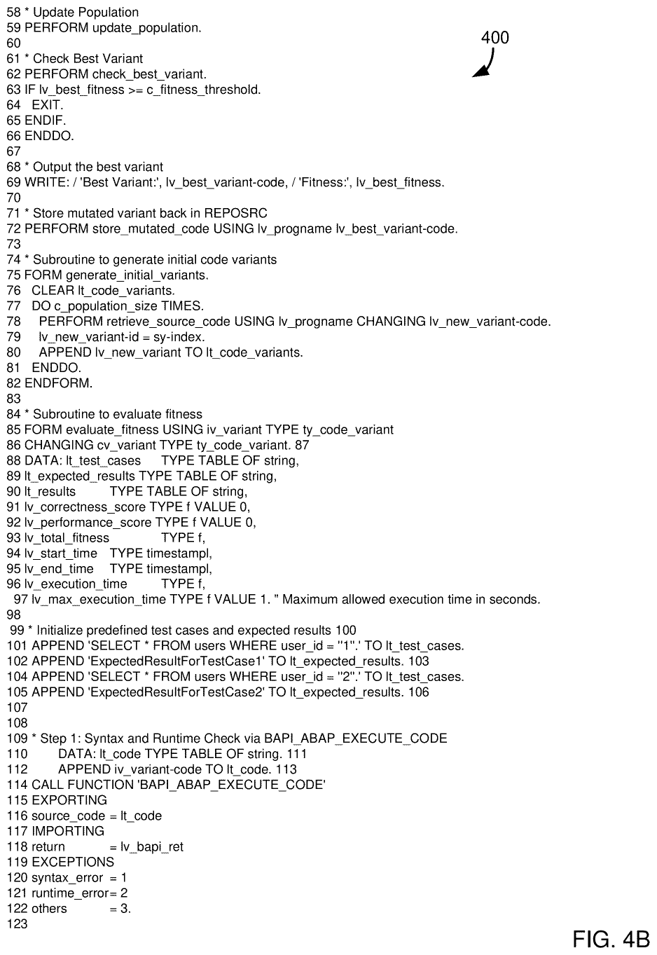

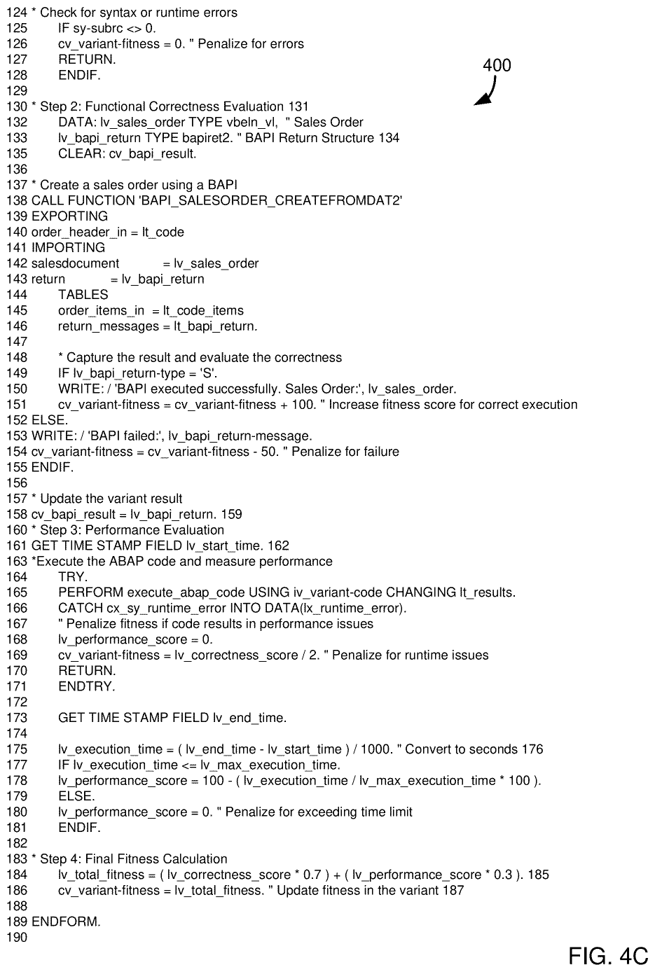

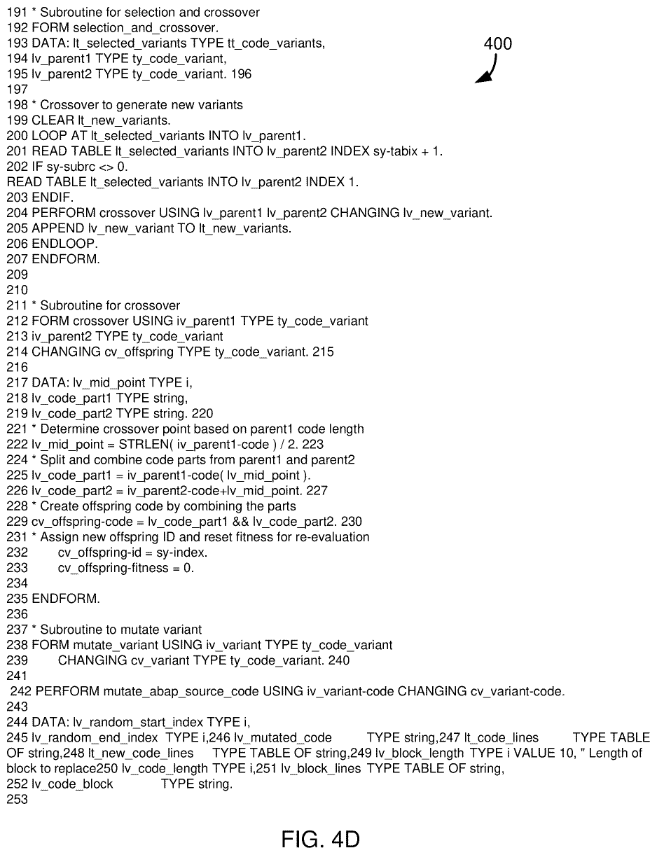

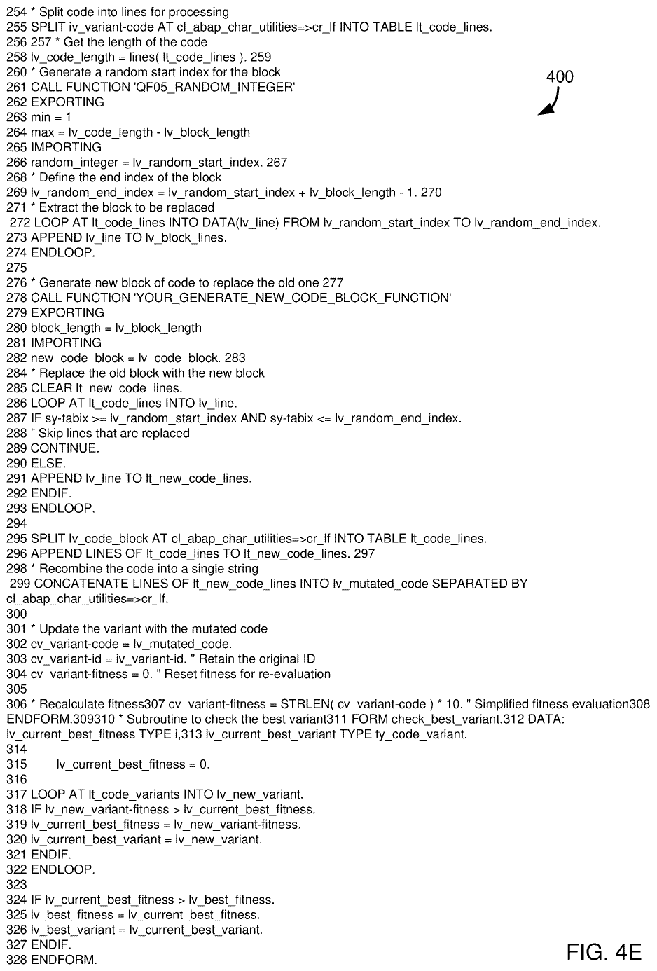

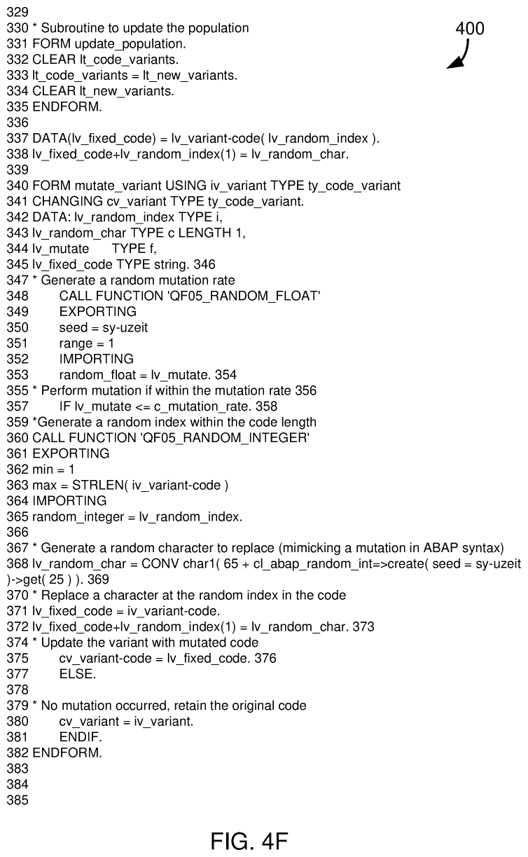

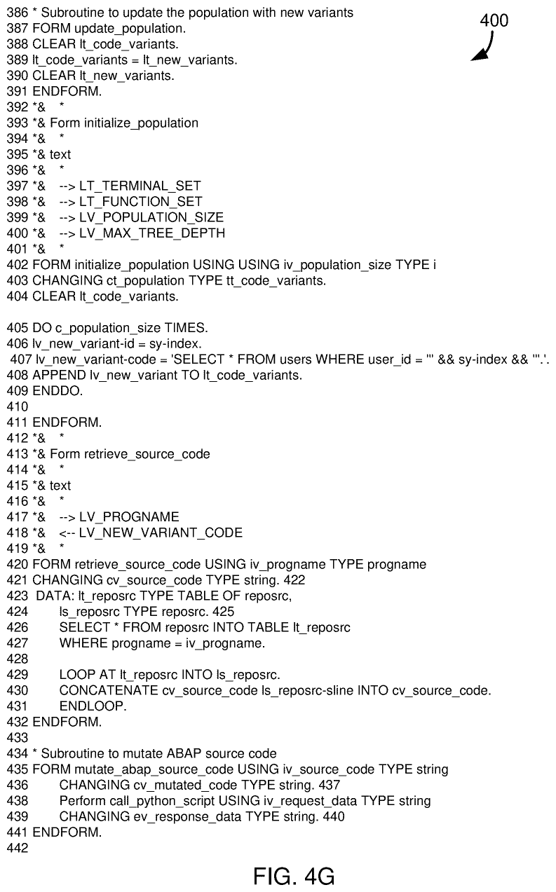

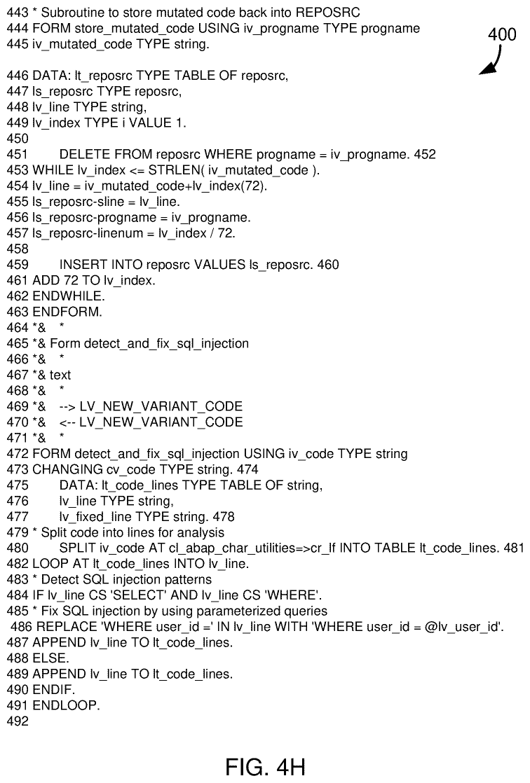

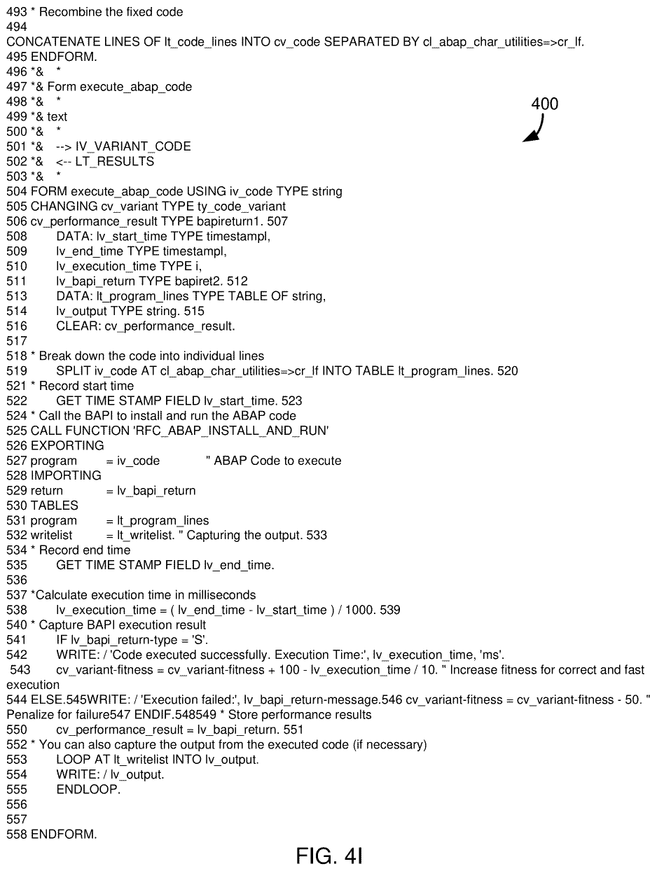

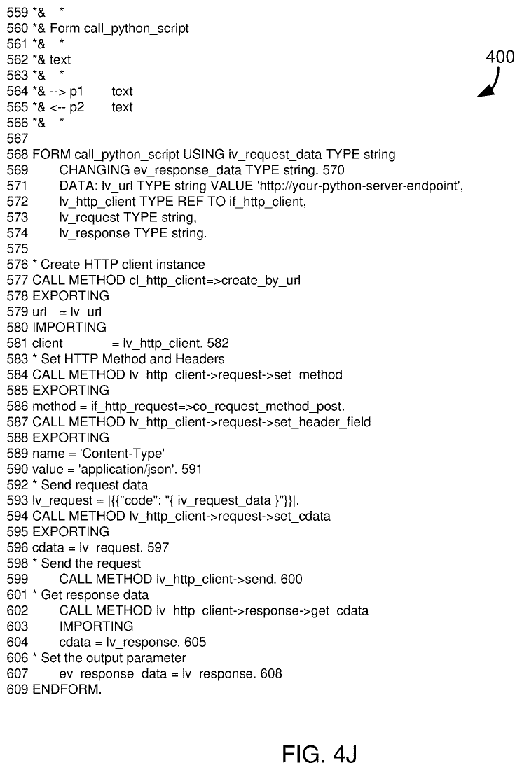

FIGS. 4A-4J illustrate example code 400 for a technique for generating and testing code variants, including using genetic programming. A general overview of the code 400 is provided, followed by a more detailed explanation.

The code 400 starts by initializing the genetic programming model and populates the initial code variants from an existing ABAP program in REPOSRC. This initial setup ensures that the genetic algorithm has a consistent starting point for generating and evolving code variants.

The detect_and_fix_sql_injection subroutine scans each variant's code for potentially vulnerable SQL queries and replaces dynamic values with parameterized queries. This enhances the security of the code by mitigating SQL injection vulnerabilities. The code 400 then mutates the source code using genetic programming techniques and evaluates the fitness of each variant by checking correctness and performance scores after running regression tests. This mutation and fitness evaluation process helps ensure that only the most robust and efficient code variants are selected for further evolution.

The evolution process continues by selecting, crossing over, and mutating variants through multiple generations until all regression tests pass with no code errors. This iterative process allows the genetic algorithm to refine the code variants progressively, improving their overall quality and performance. The code 400 outputs the best variant after evolution and stores it back into the REPOSRC table.

The following discussion provides a more detailed discussion of the code 400. The code 400 defines types and constants for the genetic algorithm, initializes the population, and starts the evolution process. The main evolution loop runs for a predefined number of generations and includes steps for mutation, fitness evaluation, selection, and crossover. Various subroutines are employed throughout the process:
generate_initial_variants: Creates initial variants of the code.
evaluate_fitness: Evaluates the fitness of each code variant based on correctness and performance.
selection_and_crossover: Selects variants and performs crossover to create new variants.
mutate_variant: Applies mutations to code variants.
check_best_variant: Identifies the best-performing code variant.
update_population: Updates the population with new variants.
store_mutated_code: Stores the best variant back into the source repository.
detect_and_fix_sql_injection: Checks for and fixes SQL injection vulnerabilities.
retrieve_source_code: Retrieves the source code from the repository.
execute_abap_code: Executes ABAP code and measures performance.
call_python_script: Calls a Python script via HTTP, useful for advanced mutation or evaluation logic.

In FIG. 4A, lines 3-10 define the data structures used to represent individual code variants. Each variant has an id, the actual code, and a fitness score. Lines 12-16 declare constants to control the genetic algorithm's parameters, including population size, maximum number of generations, fitness threshold, and mutation rate. Lines 18-24 declare variables to store the population of code variants, new variants generated during evolution, and the best variant found. Lines 26-28 initialize the genetic programming and reinforcement learning models by setting up the initial population of code variants. Lines 30-33 generate the initial set of code variants to be evolved.

In FIGS. 4A and 4B, lines 37-66 describe the main loop that iterates through a predefined number of generations. In each generation, the code 400 performs the following steps: mutation and fitness evaluation, selection and crossover, update population, and check best variant. Each variant is mutated and its fitness is evaluated (lines 40-45). The best-performing variants are selected and combined to produce new variants (lines 47-49). The population is updated with the new variants (lines 58-59). The best variant is checked against the fitness threshold (lines 61-65).

In FIG. 4B, lines 68-72 output the best variant and its fitness score, and store the best variant back in the repository. Lines 74-82 describe the subroutine that initializes the population by retrieving the source code and creating initial variants. In FIGS. 4B and 4C, lines 84-147 describe the subroutine that evaluates the fitness of each code variant by performing syntax and runtime checks, followed by functional correctness evaluation using predefined test cases (including by executing a BAPI (Business Application Programming Interface).

In FIG. 4C, lines 148-155 capture the result of the BAPI execution and evaluate the correctness of the code variant. If the BAPI execution is successful, the fitness score of the variant is increased. Otherwise, the fitness score is penalized. Lines 157-158 update the variant result with the BAPI return value. Lines 160-181 perform the performance evaluation of the code variant. The execution time of the ABAP code is measured, and the performance score is calculated based on whether the execution time is within the allowed limit. If the execution time exceeds the limit, the performance score is penalized. Lines 183-186 calculate the final fitness score of the code variant by combining the correctness and performance scores. The fitness score is then updated in the variant.

In FIG. 4D, lines 191-207 describe the subroutine for selection and crossover. This subroutine selects parent variants and performs crossover to generate new variants. The crossover operation combines parts of the code from two parent variants to create an offspring variant. The offspring variant is then added to the new variants list. Lines 211-235 describe the subroutine for crossover. This subroutine determines the crossover point based on the length of the parent1 code, splits and combines code parts from parent1 and parent2, and creates the offspring code by combining these parts. The offspring ID is assigned, and its fitness is reset for re-evaluation.

Lines 237-242 describe the subroutine to mutate a variant. This subroutine performs mutation on the ABAP source code of the variant, changing its code to introduce variations. Lines 243-252 declare additional variables used for the mutation process, including indices for random selection, code blocks, and lengths. In FIG. 4E, lines 254-255 split the code into lines for easier processing. Lines 257-258 determine the length of the code, and lines 260-266 generate a random start index for the block of code to be replaced. Lines 268-274 define the end index of the block and extract the block to be replaced.

Lines 276-283 generate a new block of code to replace the old one using a function call. Lines 285-293 replace the old block with the new block by skipping the lines that are replaced and appending the new lines. Lines 295-297 split the new code block into lines and append them to the new code lines. Lines 298-299 recombine the code into a single string.

Lines 301-304 update the variant with the mutated code, retaining the original ID and resetting the fitness for re-evaluation. Lines 306-308 recalculate the fitness of the variant using a simplified fitness evaluation based on the length of the code. Lines 310-328 describe the subroutine to check the best variant. This subroutine iterates through the code variants to find the one with the highest fitness score and updates the best variant accordingly.

In FIG. 4F, lines 330-335 describe the subroutine to update the population. This subroutine clears the current population and replaces it with the new variants. Lines 337-366 describe another subroutine for mutating a variant. This subroutine generates a random mutation rate and performs mutation if the rate is within the predefined mutation rate. It generates a random index within the code length and mutates the code at that index.

Lines 367-368 generate a random character to replace a character in the code, mimicking a mutation in ABAP syntax. Lines 370-372 replace a character at the random index in the code with the generated random character. Lines 374-375 update the variant with the mutated code. If no mutation occurs, the original code is retained (lines 377-380).

In FIG. 4G, lines 386-391 describe the subroutine to update the population with new variants. This subroutine clears the current population and replaces it with the new variants. Lines 393-411 describe the subroutine to initialize the population. This subroutine generates an initial set of code variants by creating simple SQL queries and appending them to the population.

Lines 413-432 describe the subroutine to retrieve source code. This subroutine selects the source code from the repository based on the program name and concatenates it into a single string. Lines 434-441 describe the subroutine to mutate ABAP source code. This subroutine calls an external Python script to perform the mutation and updates the mutated code.

In FIG. 4H, lines 443-463 describe the subroutine to store mutated code back into the repository. This subroutine deletes the existing code for the program name and inserts the mutated code line by line. Lines 465-491 describe the subroutine to detect and fix SQL injection vulnerabilities. This subroutine splits the code into lines for analysis, detects SQL injection patterns, and replaces them with parameterized queries to fix the vulnerabilities.

In FIG. 4I, lines 493-494 recombine the fixed code by concatenating the lines into a single string. Lines 496-558 describe the subroutine to execute ABAP code. This subroutine breaks down the code into individual lines using the line feed character, records the start time by getting the current timestamp, and calls the BAPI RFC_ABAP_INSTALL_AND_RUN to install and run the ABAP code.

The function imports the return value and captures the output. The end time is recorded by getting the timestamp after execution, and the execution time is calculated in milliseconds. The BAPI execution result is checked; if successful, a success message is written, and the fitness score is increased based on the execution time. If it fails, an error message is written, and the fitness score is penalized. The performance results are stored in cv_performance_result, and if necessary, the output from the executed code is captured by looping through the output list and writing each line.

In FIG. 4J, lines 559-609 describe the subroutine to call a Python script. This subroutine creates an HTTP client instance, sets the HTTP method and headers, sends the request data to the Python server, and retrieves the response data. The response data is then set as the output parameter.

### Example 4—Example Operations for Modifying Code to Improve Security

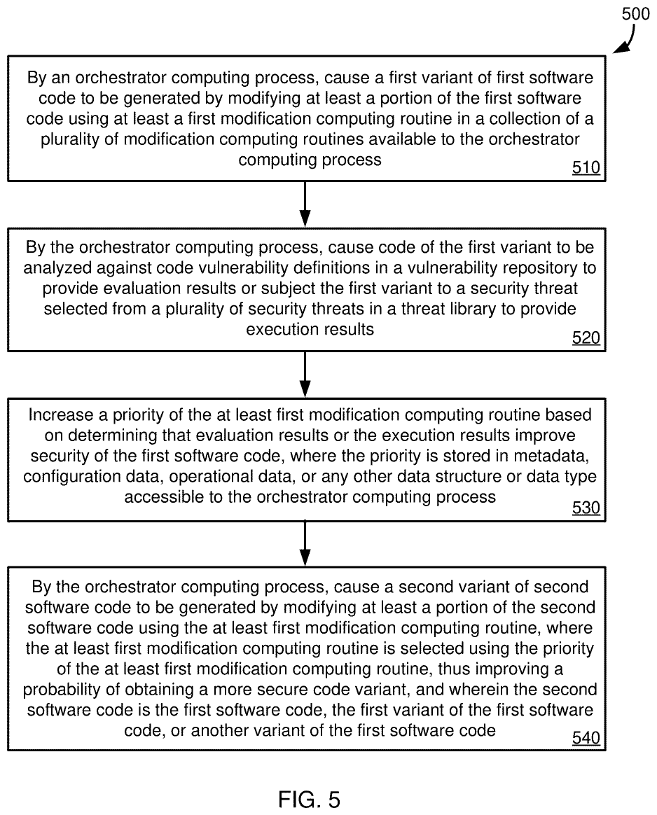

FIG. 5 provides a flowchart of a process 500 of modifying code to improve security. At 510, an orchestrator computing process causes a first variant of first software code to be generated by modifying at least a portion of the first software code using at least a first modification computing routine in a collection of a plurality of modification computing routines available to the orchestrator computing process. The orchestrator computing process causes code of the first variant to be analyzed against code vulnerability definitions in a vulnerability repository at 520 to provide evaluation results, or subjects the first variant to a security threat selected from a plurality of security threats in a threat library to provide execution results.

At 530, the priority of the at least first modification computing routine is increased based on determining that evaluation results or the execution results improve security of the first software code. The priority is stored in metadata, configuration data, operational data, or any other data structure or data type accessible to the orchestrator computing process.

The orchestrator computing process causes a second variant of second software code to be generated at 540 by modifying at least a portion of the second software code using the at least first modification computing routine. The at least first modification computing routine is selected using the priority of the at least first modification computing routine, thus improving a probability of obtaining a more secure code variant. The second software code is the first software code, the first variant of the first software code, or another variant of the first software code.

### Example 5—Additional Examples

Example 1 provides a computing system that includes at least one memory, one or more hardware processor units coupled to the at least one memory, and one or more computer-readable storage media storing computer-executable instructions. The operations include, by an orchestrator computing process, causing a first variant of first software code to be generated by modifying at least a portion of the first software code using at least a first modification computing routine in a collection of a plurality of modification computing routines available to the orchestrator computing process.

By the orchestrator computing process, code of the first variant is caused to be analyzed against code vulnerability definitions in a vulnerability repository to provide evaluation results, or the first variant is subjected to a security threat selected from a plurality of security threats in a threat library to provide execution results. A priority of the at least first modification computing routine is increased based on determining that evaluation results or the execution results improve security of the first software code, where the priority is stored in metadata, configuration data, operational data, or any other data structure or data type accessible to the orchestrator computing process.

By the orchestrator computing process, a second variant of second software code is caused to be generated by modifying at least a portion of the second software code using the at least first modification computing routine, where the at least first modification computing routine is selected using the priority of the at least first modification computing routine, thus improving a probability of obtaining a more secure code variant, and where the second software code is the first software code, the first variant of the first software code, or another variant of the first software code.

Example 2 is the computing system of Example 1, where the at least first modification routine comprises a definition of a crossover point used in genetic programming that uses the first software code and at least third software code.

Example 3 is the computing system of Example 1 or Example 2, where the operations further include selecting the first variant of first software code to be combined with a third variant of first software code based on determining that the first variant of first software code provides improved security compared with the first software code, where the third variant is the second variant or is a different variant.

Example 4 is the computing system of any of Examples 1-3, where causing the code of the first variant to be analyzed against code vulnerability definitions in the vulnerability repository includes scanning the code of the first variant for code or a coding pattern defined in a vulnerability definition of the vulnerability definitions.

Example 5 is the computing system of any of Examples 1-4, where subjecting the first variant to a security threat includes applying a security threat to an execution instance of the first variant.

Example 6 is the computing system of Example 5, where the applying is performed in a sandboxed environment.

Example 7 is the computing system of any of Examples 1-6, where the operations further include executing code of the first variant and measuring performance metrics for the first variant, and adjusting a priority of the at least a first modification computing routine based on whether the performance metrics are better or worse than performance metrics for the first software code.

Example 8 is the computing system of any of Examples 1-7, where the operations further include executing code of the first variant and measuring performance metrics for the first variant, and selecting the first variant of first software code to be combined with a second variant of first software code based on determining that the first variant of first software code is more performant than another variant of first software code.

Example 9 is the computing system of any Examples 1-8, where the operations further include deploying the first variant, monitoring execution of the first variant, and rolling back deployment of the first variant based on determining that execution of the first variant satisfies a regression threshold.

Example 10 is the computing system of any of Examples 1-9, where increasing the priority of the at least a first modification computing routine is performed using a reinforcement learning agent.

Example 11 is the computing system of Example 10, where the reinforcement learning agent is a Q-learning agent.

Example 12 is the computing system of any of Examples 1-11, where the orchestrator computing process integrates genetic programming and reinforcement learning to optimize the generation and selection of code variants by selecting the best-performing variants for future combinations or prioritizing types of crossover or mutation operations based on learned effectiveness.

Example 13 is the computing system of Example 12, where learned effectiveness includes a security improvement or an improvement in a value of a performance metric.

Example 14 is a method that is implemented in a computing system that includes at least one memory and one or more hardware processor units coupled to the at least one memory. The method includes, by an orchestrator computing process, causing a first variant of first software code to be generated by modifying at least a portion of the first software code using at least a first modification computing routine in a collection of a plurality of modification computing routines available to the orchestrator computing process. By the orchestrator computing process, code of the first variant is caused to be analyzed against code vulnerability definitions in a vulnerability repository to provide evaluation results or the first variant is subjected to a security threat selected from a plurality of security threats in a threat library to provide execution results.

A priority of the at least first modification computing routine is increased based on determining that evaluation results or the execution results improve security of the first software code, where the priority is stored in metadata, configuration data, operational data, or any other data structure or data type accessible to the orchestrator computing process. By the orchestrator computing process, a second variant of second software code is caused to be generated by modifying at least a portion of the second software code using the at least first modification computing routine, where the at least first modification computing routine is selected using the priority of the at least first modification computing routine, thus improving a probability of obtaining a more secure code variant, and where the second software code is the first software code, the first variant of the first software code, or another variant of the first software code.

Example 15 is the method of Example 14, where the at least first modification routine includes a definition of a crossover point used in genetic programming that uses the first software code and at least third software code.

Example 16 is the method of Example 14 or Example 15, further including selecting the first variant of first software code to be combined with a third variant of first software code based on determining that the first variant of first software code provides improved security compared with the first software code, where the third variant is the second variant or is a different variant.

Example 17 is one or more computer-readable storage media that include computer-executable instructions that, when executed by a computing system that includes at least one memory and at least one memory coupled to the at least one hardware processor, cause the computing system to, by an orchestrator computing process, cause a first variant of first software code to be generated by modifying at least a portion of the first software code using at least a first modification computing routine in a collection of a plurality of modification computing routines available to the orchestrator computing process.

By the orchestrator computing process, code of the first variant is caused to be analyzed against code vulnerability definitions in a vulnerability repository to provide evaluation results, or the first variant is subjected to a security threat selected from a plurality of security threats in a threat library to provide execution results. A priority of the at least first modification computing routine is increased based on determining that evaluation results or the execution results improve security of the first software code, where the priority is stored in metadata, configuration data, operational data, or any other data structure or data type accessible to the orchestrator computing process.

By the orchestrator computing process, a second variant of second software code is caused to be generated by modifying at least a portion of the second software code using the at least first modification computing routine, where the at least first modification computing routine is selected using the priority of the at least first modification computing routine, thus improving a probability of obtaining a more secure code variant, and where the second software code is the first software code, the first variant of the first software code, or another variant of the first software code.

Example 18 is the one or more computer-readable storage media of Example 17, where the at least first modification routine includes a definition of a crossover point used in genetic programming that uses the first software code and at least third software code.

Example 19 is the one or more computer-readable storage media of Example 17 or Example 18, further including computer-executable instructions that select the first variant of first software code to be combined with a third variant of first software code based on determining that the first variant of first software code provides improved security compared with the first software code, where the third variant is the second variant or is a different variant.

Example 20 is the one or more computer-readable storage media of any of Examples 17-19, where the orchestrator computing process integrates genetic programming and reinforcement learning to optimize the generation and selection of code variants by selecting the best-performing variants for future combinations or prioritizing types of crossover or mutation operations based on learned effectiveness.

### Example 6—Computing Systems

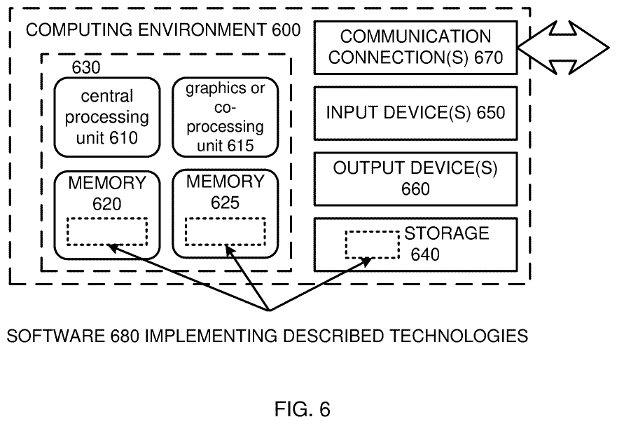

FIG. 6 depicts a generalized example of a suitable computing system 600 in which the described innovations may be implemented. The computing system 600 is not intended to suggest any limitation as to scope of use or functionality of the present disclosure, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions, such as for implementing a database environment, and associated methods, described in Examples 1-7. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s) 610, 615. The memory 620, 625 stores software 680 implementing one or more innovations described herein, in the form of computer-executable instructions suitable for execution by the processing unit(s) 610, 615.

A computing system 600 may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information in a non-transitory way, and which can be accessed within the computing system 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing system 600. The output device(s) 660 may be a display, printer, speaker, CD-writer, or another device that provides output from the computing system 600.

The communication connection(s) 670 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 7—Cloud Computing Environment

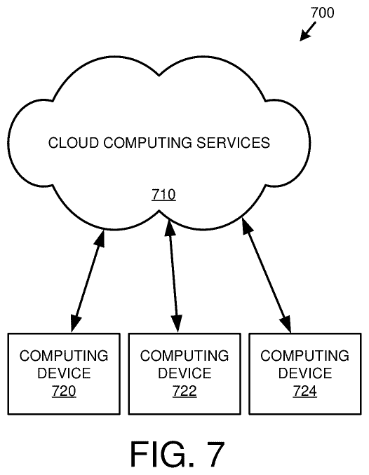

FIG. 7 depicts an example cloud computing environment 700 in which the described technologies can be implemented. The cloud computing environment 700 comprises cloud computing services 710. The cloud computing services 710 can comprise various types of cloud computing resources, such as computer servers, data storage repositories, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 are utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operators (e.g., data processing, data storage, and the like).

### Example 8—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 6, computer-readable storage media include memory 620 and 625, and storage 640. The term computer-readable storage media does not include signals and carrier waves. In addition, the term computer-readable storage media does not include communication connections (e.g., 670).

Any of the computer-executable instructions for implementing the disclosed techniques, as well as any data created and used during implementation of the disclosed embodiments, can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, Structured Query Language, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processor units coupled to the at least one memory; and
one or more computer readable storage media storing computer-executable instructions that, when executed, cause the computing system to perform operations comprising:
by an orchestrator computing process, causing a first variant of first software code to be generated by modifying at least a portion of the first software code using at least a first modification computing routine in a collection of a plurality of modification computing routines available to the orchestrator computing process;
by the orchestrator computing process, causing code of the first variant to be analyzed against code vulnerability definitions in a vulnerability repository to provide evaluation results or subjecting the first variant to a security threat selected from a plurality of security threats in a threat library to provide execution results;
increasing a priority of the at least first modification computing routine based on determining that evaluation results or the execution results improve security of the first software code, wherein the priority is stored in metadata, configuration data, operational data, or any other data structure or data type accessible to the orchestrator computing process; and
by the orchestrator computing process, causing a second variant of second software code to be generated by modifying at least a portion of the second software code using the at least first modification computing routine, wherein the at least first modification computing routine is selected using the priority of the at least first modification computing routine, thus improving a probability of obtaining a more secure code variant, and wherein the second software code is the first software code, the first variant of the first software code, or another variant of the first software code.

2. The computing system of claim 1, wherein the at least first modification routine comprises a definition of a crossover point used in genetic programming that uses the first software code and at least third software code.

3. The computing system of claim 1, the operations further comprising:
selecting the first variant of first software code to be combined with a third variant of first software code based on determining that the first variant of first software code provides improved security compared with the first software code, where the third variant is the second variant or is a different variant.

4. The computing system of claim 1, wherein causing the code of the first variant to be analyzed against code vulnerability definitions in the vulnerability repository comprising scanning the code of the first variant for code or a coding pattern defined in a vulnerability definition of the vulnerability definitions.

5. The computing system of claim 1, wherein subjecting the first variant to a security threat comprising applying a security threat to an execution instance of the first variant.

6. The computing system of claim 5, wherein the applying is performed in a sandboxed environment.

7. The computing system of claim 1, the operations further comprising
executing code of the first variant and measuring performance metrics for the first variant; and
adjusting a priority of the at least a first modification computing routine based on whether the performance metrics are better or worse than performance metrics for the first software code.

8. The computing system of claim 1, the operations further comprising:
executing code of the first variant and measuring performance metrics for the first variant; and
selecting the first variant of first software code to be combined with a second variant of first software code based on determining that the first variant of first software code is more performant than another variant of first software code.

9. The computing system of claim 1, the operations further comprising:
deploying the first variant;
monitoring execution of the first variant; and
rolling back deployment of the first variant based on determining that execution of the first variant satisfies a regression threshold.

10. The computing system of claim 1, wherein increasing the priority of the at least a first modification computing routine is performed using a reinforcement learning agent.

11. The computing system of claim 10, wherein the reinforcement learning agent is a Q-learning agent.

12. The computing system of claim 1, wherein the orchestrator computing process integrates genetic programming and reinforcement learning to optimize the generation and selection of code variants by selecting the best-performing variants for future combinations or prioritizing types of crossover or mutation operations based on learned effectiveness.

13. The computing system of claim 12, wherein learned effectiveness comprises a security improvement or an improvement in a value of a performance metric.

14. A method, implemented in a computing system comprising at least one memory and one or more hardware processor units coupled to the at least one memory, the method comprising:
by an orchestrator computing process, causing a first variant of first software code to be generated by modifying at least a portion of the first software code using at least a first modification computing routine in a collection of a plurality of modification computing routines available to the orchestrator computing process;
by the orchestrator computing process, causing code of the first variant to be analyzed against code vulnerability definitions in a vulnerability repository to provide evaluation results or subjecting the first variant to a security threat selected from a plurality of security threats in a threat library to provide execution results;
increasing a priority of the at least first modification computing routine based on determining that evaluation results or the execution results improve security of the first software code, wherein the priority is stored in metadata, configuration data, operational data, or any other data structure or data type accessible to the orchestrator computing process; and
by the orchestrator computing process, causing a second variant of second software code to be generated by modifying at least a portion of the second software code using the at least first modification computing routine, wherein the at least first modification computing routine is selected using the priority of the at least first modification computing routine, thus improving a probability of obtaining a more secure code variant, and wherein the second software code is the first software code, the first variant of the first software code, or another variant of the first software code.

15. The method of claim 14, wherein the at least first modification routine comprises a definition of a crossover point used in genetic programming that uses the first software code and at least third software code.

16. The method of claim 14, further comprising:
selecting the first variant of first software code to be combined with a third variant of first software code based on determining that the first variant of first software code provides improved security compared with the first software code, where the third variant is the second variant or is a different variant.

17. One or more computer-readable storage media comprising:
computer-executable instructions that, when executed by a computing system comprising at least one memory and at least one memory coupled to the at least one hardware processor, cause the computing system to, by an orchestrator computing process, cause a first variant of first software code to be generated by modifying at least a portion of the first software code using at least a first modification computing routine in a collection of a plurality of modification computing routines available to the orchestrator computing process;
computer-executable instructions that, when executed by the computing system, cause the computing system to, by the orchestrator computing process, cause code of the first variant to be analyzed against code vulnerability definitions in a vulnerability repository to provide evaluation results or subjecting the first variant to a security threat selected from a plurality of security threats in a threat library to provide execution results;
computer-executable instructions that, when executed by the computing system, cause the computing system to increase a priority of the at least first modification computing routine based on determining that evaluation results or the execution results improve security of the first software code, wherein the priority is stored in metadata, configuration data, operational data, or any other data structure or data type accessible to the orchestrator computing process; and
computer-executable instructions that, when executed by the computing system, cause the computing system to, by the orchestrator computing process, cause a second variant of second software code to be generated by modifying at least a portion of the second software code using the at least first modification computing routine, wherein the at least first modification computing routine is selected using the priority of the at least first modification computing routine, thus improving a probability of obtaining a more secure code variant, and wherein the second software code is the first software code, the first variant of the first software code, or another variant of the first software code.

18. The one or more computer-readable storage media of claim 17, wherein the at least first modification routine comprises a definition of a crossover point used in genetic programming that uses the first software code and at least third software code.

19. The one or more computer-readable storage media of claim 17, further comprising:
computer-executable instructions that, when executed by the computing system, cause the computing system to select the first variant of first software code to be combined with a third variant of first software code based on determining that the first variant of first software code provides improved security compared with the first software code, where the third variant is the second variant or is a different variant.

20. The one or more computer-readable storage media of claim 17, wherein the orchestrator computing process integrates genetic programming and reinforcement learning to optimize the generation and selection of code variants by selecting the best-performing variants for future combinations or prioritizing types of crossover or mutation operations based on learned effectiveness.
